(19) United States
(12) Patent Application Publication
(10) Pub. No.: US 2010/0164303 A1
(43) Pub. Date: Jul. 1, 2010

(54) Submersible motor with ferrofluid gap

(75) Inventor: Anthony Veneruso, Sugar Land, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, SUGAR LAND, TX (US)

(21) Appl. No.: 12/619,812

(22) Filed: Nov. 17, 2009

Related U.S. Application Data
(60) Provisional application No. 61/141,875, filed on Dec. 31, 2008.

(51) Int. Cl. H02K 1/02; H02K 15/00

(52) U.S. Cl. 310/11; 29/596

(57) ABSTRACT

A technique enables reduction in electrical power losses during operation of a submersible motor. The technique utilizes a submersible motor comprising a housing that encloses a stator and a rotor. A ferrofluid is located in the housing in a sufficient quantity to fill the gap between rotor and stator. The ferrofluid has substantially improved properties that facilitate a reduction in electrical power supplied and thus a greater efficiency in operation of the motor.

### CROSS-REFERENCE TO RELATED APPLICATION

The present application is based on and claims priority to U.S. Provisional Application Ser. No. 61/141,875, filed Dec. 31, 2008.

### BACKGROUND

In a variety of well related applications, power for pumping or other work is provided by submersible electric motors. In electric submersible pumping systems, for example, oil-filled motors are used to power pumps that move fluid in the downhole environment. By filling the motors with oil, the submersible motors can be designed with relatively thin walled housings that can fit downhole and operate under wellbore pressure. However, an undesired side effect is large viscous power losses in the motor that are costly to supply via electrical power delivered downhole over long electric lines. The additional electric power required to overcome the viscous drag does no useful work. Instead, the added electrical current increases the heat dissipated within the motor windings and within the long power cable. Consequently, higher voltage is required at the surface to overcome losses in the power cable. All of these effects introduce added risks, stresses, and operating costs with respect to the pumping system.

Conventional electric submersible pumping system motors typically run in dielectric oil filled housings to achieve a pressure balance between an interior of the motor and the wellbore fluid pressure along an exterior of the motor. The pressure balancing avoids the need for a thick walled pressure vessel able to withstand large pressure differentials. The concept of oil-filled, pressure balanced motors was incorporated by Armais Artunoff into his early electric submersible pumping systems around the year 1916. Although the dielectric oil helps to pressure balance and protect the submersible motor from the borehole fluid, the dielectric fluid does little to improve the electromagnetic performance of the motor because dielectric oil has approximately the same electromagnetic properties as air.

Unfortunately, this characteristic results in significantly greater electrical current being applied to the motor's windings to overcome the added viscous friction from rotating the oil within the submersible motor. This additional current produces more heat and eddy current losses in the motor. Also, the additional current is carried downhole over long power cables which results in substantial resistive losses. The net result is higher operating costs, lower reliability, and reduced longevity because of the higher heat dissipated and higher voltages required in delivering sufficient power to the motor.

### SUMMARY

In general, the present application provides a technique for reducing electrical power losses in a submersible motor. A technique utilizes a submersible motor comprising a housing that encloses a stator and a rotor. A ferrofluid is located in the housing in a sufficient quantity to fill the gap between rotor and stator. The ferrofluid has substantially improved properties that facilitate a reduction in electrical power supplied and thus a greater efficiency in operation of the motor.

### BRIEF DESCRIPTION OF THE DRAWINGS

Certain embodiments will hereafter be described with reference to the accompanying drawings, wherein like reference numerals denote like elements, and:

FIG. 1 is a schematic illustration of one example of a motor system, according to an embodiment;

FIG. 2 is a cross-sectional view of the motor system illustrated in FIG. 1 taken generally across an axis of the motor, according to an embodiment;

FIG. 3 is a schematic illustration of one example of wellbore equipment utilizing a submersible motor, according to an embodiment; and

FIG. 4 is a flowchart illustrating one methodology for preparing a motor system for use in a submerged environment, according to an embodiment.

### DETAILED DESCRIPTION

In the following description, numerous details are set forth to provide an understanding of preferred embodiments. However, it will be understood by those of ordinary skill in the art that various embodiments may be practiced without these details and that numerous variations or modifications from the described embodiments may be possible.

A preferred embodiment generally involves a system and methodology related to the construction and use of submersible motors. The system and methodology substantially improve the efficiency of motor operation and thus reduce the amount of electric power that must be directed to the motor at subterranean locations via a lengthy power cable. In some applications, the submersible motor is employed in artificial lift systems, such as electric submersible pumping systems. However, the motor also can be incorporated into other well related equipment for powering a variety of systems and/or components, such as formation tester pumps, electro-hydraulic actuators, drives for flow control valves, and other devices. The approach provides the electric motor with significantly lower operating costs, longer life, and higher reliability.

According to one embodiment, the motor is designed to use an internal liquid magnetic material called ferrofluid. Depending on the application, the ferrofluid can be used to substantially fill the interior of the motor. For example, the ferrofluid is disposed within the motor housing to fill gaps between rotating parts and other gaps within the magnetic circuit of the motor. Use of the ferrofluid significantly reduces the magnetic reluctance of the motor. The reduced magnetic reluctance, in turn, increases motor performance and reliability by significantly reducing the required current and electrical power supplied to produce a required level of magnetic flux and hence power output.

When the motor is used in electric submersible pumping (ESP) systems, for example, the unique motor construction significantly reduces the electrical current required to drive the ESP motor at its rated speed and power output compared to conventional ESP motors. In one embodiment of the motor suitable for use in electric submersible pumping systems, the ferrofluid is mixed with dielectric oil to improve the magnetic circuit performance of the critical gap between the rotor and stator of the motor. This approach again significantly reduces the magnetic reluctance of the motor to produce a required magnetic flux for a given amount of current. Consequently, there is a significant reduction in the amount of current that must be supplied downhole to produce a specified rotating magnetic field.

In electric submersible pumping system applications, the unique motor leads to further increases in efficiency because less power must be generated and sent over long power cables routed downhole to the ESP motor. A lower current can be supplied to the motor without sacrificing operational functionality of the pumping system. Reducing the current for a given power output reduces the resistive losses in the power cable which also reduces the voltage required from a surface voltage source.

In motors constructed with a rotor and stator, use of ferrofluid, including ferrofluid mixtures, in the gap between the rotor and the stator significantly adds to the reduction of reluctance of the magnetic circuit of the motor. In conventional submersible motors, the dielectric oil gap is very similar to an air gap between the rotor and stator. The dielectric oil/air gap dominates the reluctance of the magnetic circuit of the motor in which a magnetic flux, B, can be established by the electrical current, I, supplied from the surface via the long ESP cables. The relation between the current and the flux may be approximated by:

NI=B{Lm/μₘ+Lg/μₒ}

In the above equation N is the number of turns through which the current flows through the motor;

Lₘ is the equivalent magnetic path length through the motor's laminations and rotor;

L_{g} is the air gap length, in the case of an ESP motor, the oil gap length;

μₒ is the magnetic permeability of free space;

μₘ is the magnetic permeability of the motor's iron alloy laminations.

A comparison can be made between the current required in a ferrofluid filled ESP motor and a standard ESP motor, for the same power output from the same type ESP motor using the same number of turns and metal parts. For these two motors N, B, Lm and Lg, and μₘ are therefore the same. The ratio of the currents flowing in the ferrofluid motor and the standard motor can be calculated as:

I_{ff}/I={Lm/(μₘ)+Lg/(μₒ)}/{Lm/μₘ+Lg/μₒ}

Here μ_{ff} is the relative magnetic permeability of the ferrofluid compared to that of free space.

The current reduction can be estimated to a first order approximation by assuming that the reluctance of the gap dominates the motor's reluctance in both cases; hence:

I_{ff}/I˜1/μ_{ff}

Because a ferrofluid's permeability, μ_{ff} is typically greater than 1; the current in the ferrofluid equipped motor is a fraction of the current required in a conventional oil-filled motor of the same dimensions and materials. The exact amount of the improvement depends on the motor's design and the specific ferrofluid formulated.

Ferrofluids are stable colloidal suspensions of nano-size ferromagnetic particles in either aqueous or oil-based media. Typically, the magnetic particles are magnetite (an iron oxide) having diameters of about 10 nanometers (nm). These particles can be obtained as precipitates of simple chemical reactions. A surfactant layer covers the surface of the nano-particles and helps overcome the Van der Waals forces by preventing the particles from coming too close together and clumping or settling down due to gravity. Ferrofluids improve heat transfer, serve as good lubricants, and can also be formulated to operate over a wide temperature range up to, for example, 200° C. Ferrofluids improve motor cooling because ferrofluid magnetic properties vary inversely with temperature; the strong magnet fields of the motor's windings (which produce heat) attract cold ferrofluid more than hot ferrofluid thus forcing the heated ferrofluid away from the windings and toward cooler surfaces. This efficient cooling method requires up to no additional energy input. Ferrofluids have been discussed in various publications, such as R. E. Rosensweig, “Ferrohydrodynamics,” Cambridge University Press, Cambridge, (1985); and Elmars Blums (1995), “New Applications of Heat and Mass Transfer Processes in Temperature Sensitive Magnetic Fluids”, Brazilian Journal of Physics. Additionally, certain types of ferrofluids are available from Ferrotec Company of Tokyo, Japan.

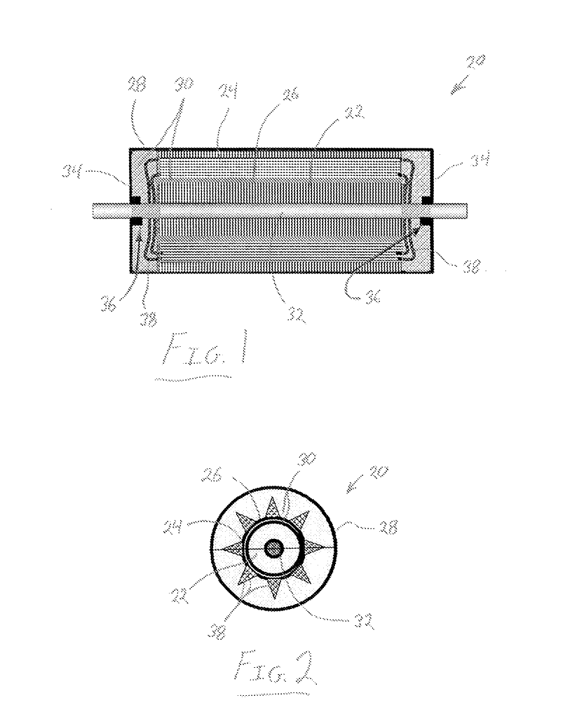

Referring generally to FIG. 1, an embodiment of a motor 20, e.g. a submersible motor, is illustrated. By way of example, motor 20 is a submersible motor having a rotor 22 rotatably mounted within a stator 24 such that a gap 26 is formed around the rotor 22 between the rotor and the stator. The rotor 22 and stator 24 are enclosed by a motor housing 28, and a ferrofluid 30 is disposed within motor housing 28. For example, the ferrofluid 30 may be disposed in gap 26 to substantially increase the efficiency of motor 20. In some embodiments, the interior of motor housing 28 is substantially filled with ferrofluid to substantially fill gaps between the rotating components of motor 20 and other gaps and spaces within its magnetic circuit. The ferrofluid 30 reduces the magnetic reluctance of motor 20 and increases its performance and reliability by significantly reducing the required current and electrical power that must be supplied to motor 20 to produce a required level of magnetic flux and resulting power output. In some applications, ferrofluid 30 may comprise ferrofluid mixtures including ferrofluid mixed with dielectric oil.

Motor 20 also may comprise a variety of other components. For example, rotor 22 may be mounted on a rotatable shaft 32 for rotation within stator 24, as further illustrated in FIG. 2. The rotatable shaft 32 may extend through one or both longitudinal ends 34 of motor housing 28. In the embodiment illustrated, ferrofluid 30 is sealed within the interior of motor housing 28 by ferrofluid seals 36 that may be disposed around shaft 32 proximate longitudinal ends 34 of housing 28. Additionally, motor 20 may comprise windings 38 and a variety of other or alternate components depending on the equipment with which motor 20 is engaged, the power requirements of the motor, the environment in which the motor is operated, and various design considerations.

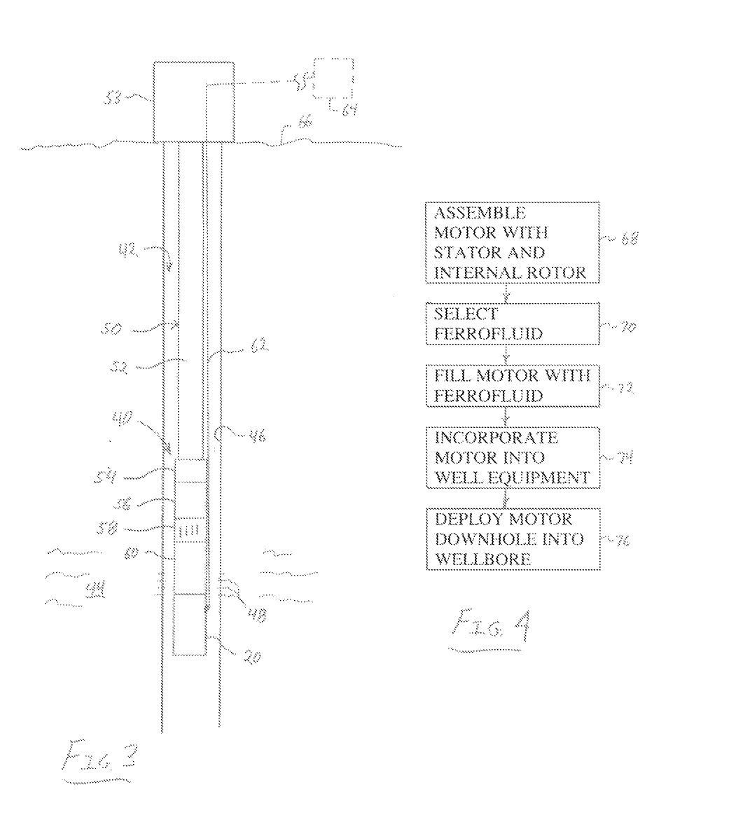

In one specific example, motor 20 is a submersible motor incorporated into an electric submersible pumping system 40, as illustrated in FIG. 3. The electric submersible pumping system 40 may be constructed in a variety of forms with different components depending on the environment and application requirements. In the particular application illustrated, electric submersible pumping system 40 is deployed in a wellbore 42 drilled into a geological formation 44. The wellbore 42 may be lined with a casing 46 that is perforated with a plurality of perforations 48 to allow well fluid to flow into the interior of casing 46.

The electric submersible pumping system 40 is deployed to a desired location in wellbore 42 via a conveyance 50 which may be in the form of a tubing 52, e.g. coiled tubing, or other suitable conveyance that extends down from, for example, a wellhead 53. The pumping system 40 is connected to conveyance 50 by a connector 54 and may comprise a variety of pumping related components. For example, electric submersible pumping system 40 may comprise a submersible pump 56 connected to a pump intake 58. The pump intake 58 allows well fluid to be drawn into submersible pump 56 when pump 56 is powered by submersible motor 20. In many applications, a motor protector 60 is located between submersible motor 20 and pump 56 to enable pressure equalization while isolating motor fluid from well fluid.

In the embodiment illustrated in FIG. 3, power is supplied to submersible motor 20 via a power cable 62. The use of ferrofluid 30 in submersible motor 20 enables substantially less current flow through power cable 62, when compared to a conventional system, while achieving the same performance with respect to submersible motor 20 and pumping system 38. The reduction in current required for a given output of motor 20 also reduces the resistive losses in power cable 62 and reduces the voltage required from a power source, such as power source 64 positioned at a surface location 66.

Referring generally to FIG. 4, a flow chart is provided to illustrate one approach for reducing electrical power consumption during operation of subterranean equipment, such as during operation of an electric submersible pumping system. In this example, motor 20 is initially assembled with a stator and a rotor deployed along an interior of the stator, as illustrated by block 68. Depending on the specific application, a suitable ferrofluid 30 is selected, as illustrated by block 70. The motor is filled with the ferrofluid 30 to enable substantially improved efficiency during operation of the motor, as illustrated by block 72.

The ferrofluid filled motor 20 is incorporated into the desired well equipment, as illustrated by block 74. The motor 20 may be incorporated into an electric submersible pumping system, however the motor also may be incorporated into formation tester pump systems, electro-hydraulic actuator systems, electric motor driven flow control valve systems, and other well systems that can be powered via motor 20. In at least some of these embodiments, the ferrofluid filled motor 20 and its associated equipment are deployed downhole into a wellbore, as illustrated by block 76. Once deployed downhole, a relatively reduced amount of electrical power can be supplied via a suitable power cable or power cables to the motor 20.

Ferrofluid filled motor 20 provides substantially increased efficiency that is beneficial in a variety of environments. In downhole applications, the unique design of motor 20 simplifies the transfer and reduces the cost of delivering electrical power over substantial distances downhole. However, motor 20 can be used in a variety of systems, applications and environments. Additionally, individual motors or combinations of motors 20 can be used. In some electric submersible pumping systems, for example, a plurality of motors 20 is used to provide power to one or more submersible pumps. Depending on the specific motor application, the size, configuration, and materials used to construct motor 20 may vary. The ferrofluid may be contained within motor 20 via the ferrofluid seals, or other seals or motor protectors can be used to contain the fluid while enabling equalization of pressure.

Although only a few embodiments have been described in detail above, those of ordinary skill in the art will readily appreciate that many modifications are possible without materially departing from the teachings of this application. Accordingly, such modifications are intended to be included within the scope of this invention as defined in the claims. These embodiments are not meant to unduly limit the present claims herein or any subsequent related claims.

What is claimed is:

1. A system for reducing electrical power consumption, comprising:
a submersible motor comprising a housing enclosing a stator and a rotor; and
a ferrofluid located in the housing in a sufficient quantity to substantially submerge the stator and the rotor.

2. The system as recited in claim 1, wherein the rotor is mounted on a shaft that extends through longitudinal ends of the housing.

3. The system as recited in claim 2, further comprising a ferrofluid seal mounted about the shaft at each longitudinal end of the housing.

4. A method, comprising:
preparing a motor with a rotor rotatably mounted within a stator such that a gap exists between the rotor and the stator; and
filling the gap with a ferrofluid.

5. The method as recited in claim 4, wherein preparing comprises enclosing the rotor and the stator within a housing.

6. The method as recited in claim 5, wherein preparing comprises mounting the rotor on a shaft that extends through a longitudinal end of the housing.

7. The method as recited in claim 6, further comprising mounting a ferrofluid seal about the shaft at the longitudinal end of the housing.

8. The method as recited in claim 4, further comprising coupling the motor into an electric submersible pumping system.

9. The method as recited in claim 8, further comprising conveying the electric submersible pumping system downhole into a wellbore.

10. The method as recited in claim 9, further comprising delivering electric power to the motor via a power cable extending down through the wellbore from a surface location.

11. The method as recited in claim 4, further comprising forming the ferrofluid with an oil-based media.

12. A system, comprising:
an electric submersible pumping system having:
a submersible pump;
a pump intake;
a motor protector; and
a submersible motor to power the submersible pump, the submersible motor being at least partially filled with a ferrofluid.

13. The system as recited in claim 12, wherein the submersible motor comprises a rotor mounted for rotation on a shaft, the rotor been disposed within a stator.

14. The system as recited in claim 13, wherein the submersible motor comprises a plurality of ferrofluid seals disposed around the shaft.

15. The system as recited in claim 12, wherein the ferrofluid is formed with an oil-based media.

16. A method of cooling a device, comprising:
selecting a fluid having magnetic properties that vary inversely with temperature;
filling at least a portion of an electric motor with the fluid; and
using the fluid to improve cooling of the electric motor.

17. The method as recited in claim 16, wherein selecting the fluid comprises selecting a ferrofluid.

18. The method as recited in claim 17, further comprising connecting the electric motor to an electric submersible pumping system.

19. The method as recited in claim 17, further comprising operating the electric motor in a wellbore.

20. The method as recited in claim 17, further comprising operating the electric motor in a submerged environment.
